(19) United States
(12) Patent Application Publication
(10) Pub. No.: US 2006/0076103 A1
(43) Pub. Date: Apr. 13, 2006

(54) Method for manufacturing sensors having wavy elements

(75) Inventor: Colin F. Clarke, Victoria (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Tactex Controls Inc., Victoria (CA)

(21) Appl. No.: 11/246,197

(22) Filed: Oct. 11, 2005

Related U.S. Application Data
(60) Provisional application No. 60/616,634, filed on Oct. 8, 2004.

(51) Int. Cl. B29C 70/52; B29C 65/00; B32B 37/00

(52) U.S. Cl. 156/229; 156/166; 156/180

(57) ABSTRACT

A method for manufacturing composite structures comprising elongated flexible elements arranged in sinuous configurations involves providing an elastically-extendable substrate layer. The method comprises stretching the elastically-extendible layer and attaching the elongated flexible elements to the layer at spaced-apart locations. When the layer is allowed to relax, the elongated elements assume sinuous configurations. The method may be used to make pressure sensors or other devices.

### CROSS REFERENCE TO RELATED APPLICATION

This application claims the benefit of U.S. application No. 60/616,634 filed on 10 Oct. 2004 and entitled METHOD FOR MANUFACTURING A SENSOR HAVING WAVY CONDUCTORS, which is hereby incorporated by reference herein.

### FIELD OF THE INVENTION

This invention relates to the manufacture of products that include a sinuous (i.e. wavy or serpentine) arrangement of one or more elongated elements the elongated elements may comprise conductors, such as optical fibres, wires or the like. Particular embodiments of this invention relate to the manufacture of sensors in which one or more optical fibres are arranged in a sinuous manner. For example, this invention may be applied in the manufacture of fibre-optic pressure sensors of the general type disclosed in Lokhorst et al (PCT Publication WO 2004/006768).

### BACKGROUND

Some sensors have optical fibres or other flexible conductors, disposed in sinuous arrangements. Examples of such sensors are described in U.S. Pat. No. 4,947,693 (Szuchy et al.), U.S. Pat. No. 4,408,495 (Couch et al.), and U.S. Pat. No. 6,854,327 (Rambox et al.). A sinuous arrangement can be desirable both for its effects on the transmission properties of conductors and also because such an arrangement can contribute to the overall flexibility, resiliency and reliability of a sensor or other device.

One difficulty in the mass production of sensors of the general type described by Lokhorst et al. involves finding an efficient way to arrange optical fibres or other conductors in a neat, sinuous, arrangement. Fabricating sensors that include such arrangements by hand is unduly expensive and time consuming for many applications. A cost-effective method for manufacturing such sensors is therefore desirable. Such methods could also be applied to advantage in fabricating products of other types that include arrangements of sinuous elements on a substrate.

There is a need for methods for making sensors or other devices having sinuous arrangements of flexible elongated elements, such as optical fibres, wires or other conductors.

### SUMMARY OF THE INVENTION

In general, the invention relates to methods and associated apparatus for the manufacture of sensors or other devices that include sinuous arrangements of flexible elongated elements such as optical fibres, wires or other conductors.

One aspect of the invention provides a method for manufacturing a composite structure comprising an elastically-extendable layer and one or more elongated flexible elements. The method involves stretching the elastically-extendable layer and attaching the elongated flexible elements to the stretched elastically-extendable layer at a plurality of locations that are spaced apart along the elastically-extendable layer in a direction of the stretch. Attaching the elongated flexible elements to the elastically-extendable layer may comprise applying adhesive to the elastically-extendable layer, the elongated flexible elements, or both and adhering the elongated flexible elements to the stretched elastically-extendible layer. The elongated flexible elements may be held to be straight, for example by applying some tension to them, while they are being attached to the elastically-extendible layer. The method relaxes the elastically-extendable layer and allows the elongated elements to assume sinuous configurations as the points of attachment between the elongated elements and the elastically-extendible layer become closer together.

A further aspect of the invention provides an apparatus that has application for manufacturing composite structures comprising an elastically-extendable layer and one or more elongated flexible elements. The apparatus includes a support surface and clamps disposed on opposite sides of the support surface. The clamps are mounted adjacent to the support surface. At least one clamp is movable toward or away from at least one other one of the clamps.

Yet another aspect of the invention relates to the use of such an apparatus for manufacturing a composite structure comprising an elastically-extendable layer and one or more elongated flexible elements.

Further aspects of the invention and features of embodiments of the invention are described below.

### DESCRIPTION OF THE DRAWINGS

In drawings which illustrate non-limiting embodiments of the invention:

FIG. 1 is a schematic illustration of a pressure sensor having an arrangement of sinuously disposed conductors;

FIG. 2 is a detailed view showing optical fibre pairs terminating on adhesive areas in the pressure sensor of FIG. 1;

FIG. 3 shows optical fibre pairs sandwiched between two layers of a compressible material in a pressure sensor;

FIG. 4 shows a mechanical jig according to one embodiment of the invention;

FIG. 5 is a flow chart illustrating a method according to the invention;

FIGS. 6A and 6B show a substrate layer before and after stretching according to one embodiment of the invention; and,

FIGS. 7A and 7B show a substrate layer and optical fibre pairs before and after relaxation according to one embodiment of the invention.

### DETAILED DESCRIPTION

Throughout the following description, specific details are set forth in order to provide a more thorough understanding of the invention. However, the invention may be practiced without these particulars. In other instances, well known elements have not been shown or described in detail to avoid unnecessarily obscuring the invention. Accordingly, the specification and drawings are to be regarded in an illustrative, rather than a restrictive, sense.

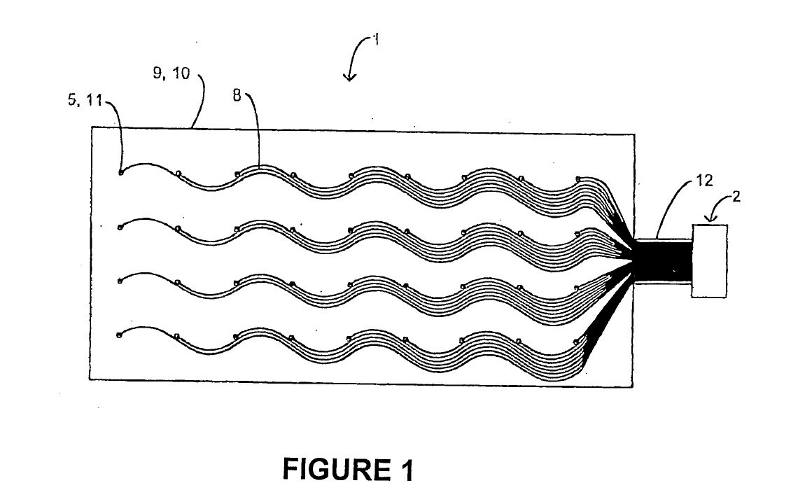

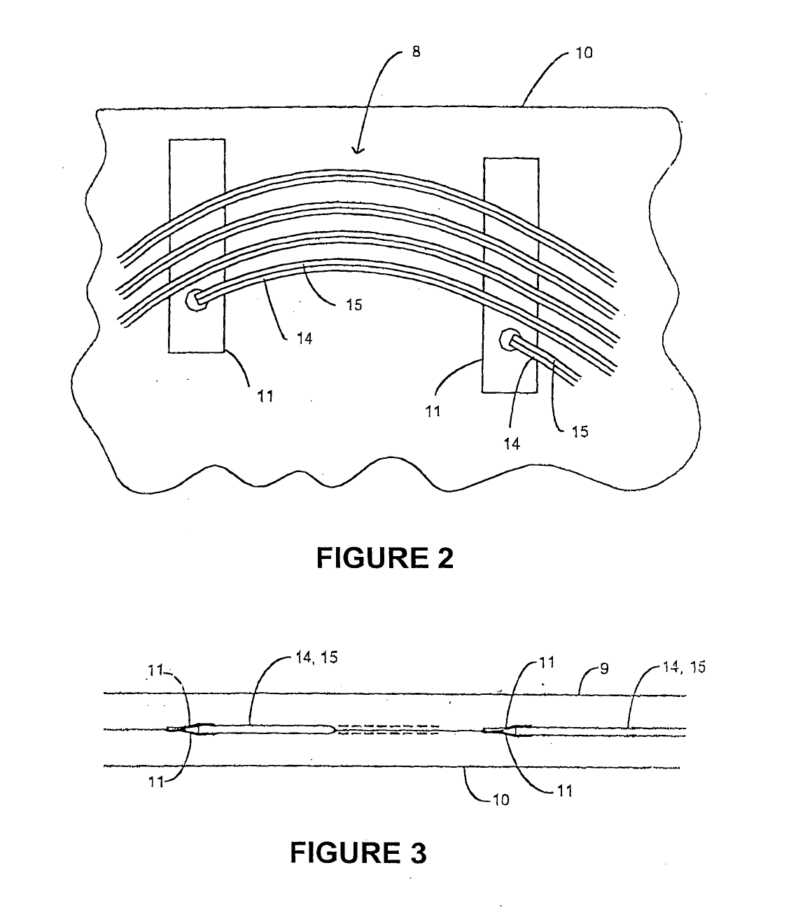

FIGS. 1, 2, and 3 illustrate a context in which this invention may be applied. These Figures show a pressure sensing pad 1 of the general type disclosed by Lokhorst et al. Pressure sensing pad 1 comprises a plurality of pressure sensors 5. Each sensor 5 may be constructed as described, for example, in Reimer et al. (U.S. Pat. No. 5,917,180). Pressure sensors 5 are formed at locations where the ends of a pair 14, 15 of optical fibres 8 are sandwiched between two layers 9,10 of a compressible material.

In the illustrated embodiment, several bundles 7 of optical fibre pairs 14, 15 carry light energy to and from the pressure sensors 5. It is generally desirable that pad 1 be flexible. Optical fibres 8 are secured to the layers of compressible material 9,10 above and below each sensor 5 by areas of adhesive 11. Other portions of optical fibres 8 are left free so as to provide some flexibility and resilience to the entire assembly.

In the assembled device, optical fibres 8 are not stretched tightly and do not extend in straight lines to sensors 5 but follow sinuous paths. It can be difficult to repeatably form fibres 8 into the desired sinuous configurations and then attach the fibres 8 to compressible material layers 9, 10.

A method for manufacturing a sensor or other device having a structure like that of pad 1, involves stretching an elastic substrate layer that will be adjacent to the fibres, or other flexible elongated elements, of the device. For example, if a sensor pad of the type shown in FIGS. 1, 2 and 3 is being made, the elastic substrate layer may comprise top layer 9, bottom layer 10 or another layer to be adjacent to bottom layer 10 or top layer 9.

The method involves placing fibres 8 (or other flexible elongated members) on the stretched substrate layer in a substantially straight manner. Fibres 8 are then attached to the substrate layer at spaced-apart locations. The substrate layer is then allowed to relax. Relaxation of the substrate layer constricts the entire assembly and, in particular, brings together the locations at which the fibres are attached to the substrate layer, thereby forcing the fibres to assume a sinuous arrangement.

The size of the meanders in fibres 8 may be adjusted by selecting an amount by which the substrate layer is stretched and a distance between the locations where fibres 8 are attached to the substrate layer. In some embodiments, the locations where the fibres, or other elongated elements, are attached to the substrate layer are, at least approximately, equally spaced apart.

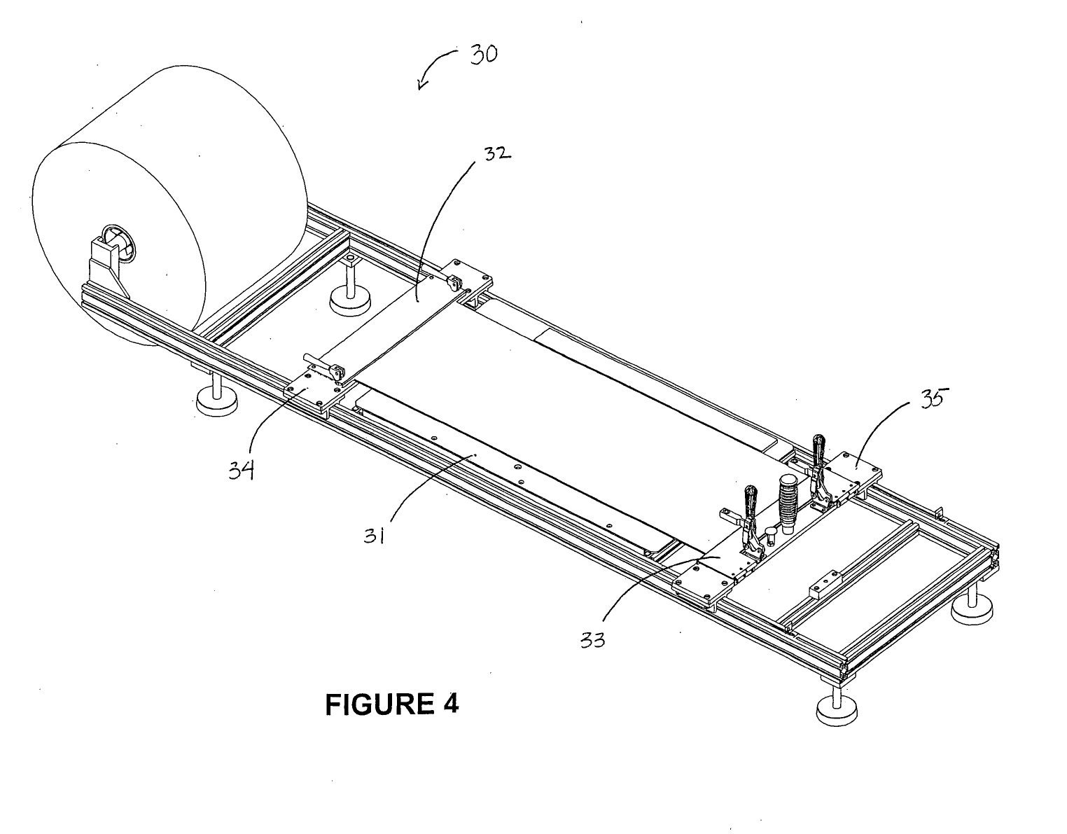

A mechanical jig may be used in the practice of the invention. FIG. 4 shows a jig 30 according to one embodiment of the invention. Jig 30 includes a support surface 31 and two clamps 34, 35. Clamps 34 and 35 are mounted adjacent to opposite edges of support surface 31. Clamps 34, 35 can be locked in place in relation to support surface 31. At least one of the clamps is movable so that the clamps can be slid apart from one another.

Clamps 34, 35 can each be opened to receive an edge of a sheet of material 10 and then closed to grip the material 10. In the illustrated embodiment, each clamp comprises a jaw (32 and 33 respectively) that extends substantially the full width of a sheet of material 10.

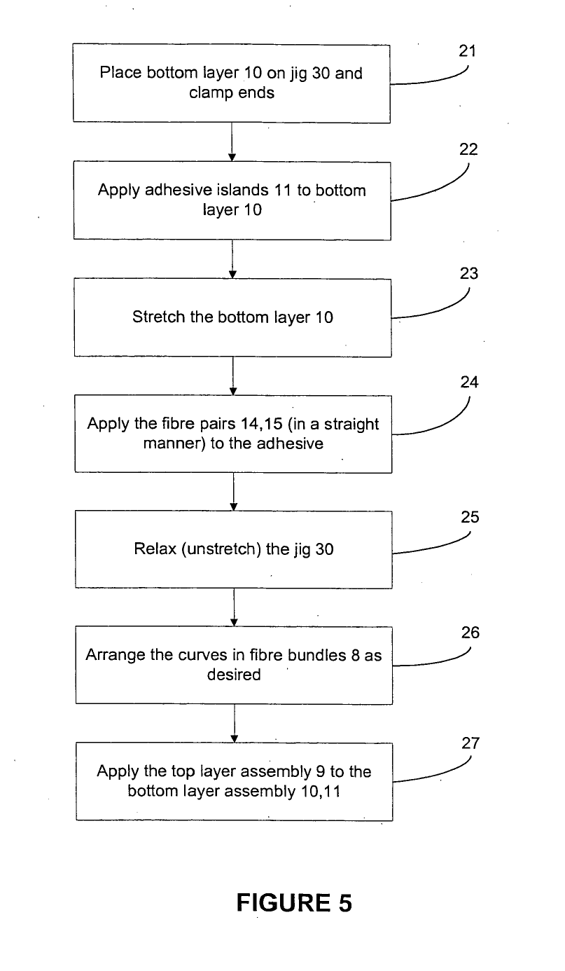

FIG. 5 is a flow chart of a method 20 according to an embodiment of the invention.

In block 21 a substrate layer (e.g. bottom layer 10) is placed on support surface 31 of jig 30. The substrate layer is arranged such that its ends can be engaged by the jaws 32, 33 of clamps 34, 35. Jaws 32, 33 of clamps 34, 35 are then closed to secure the ends of the substrate layer to the clamps.

In block 22 an area of adhesive 11 is applied to the substrate layer at each location where it is desired to secure a fibre 8 (or other elongated flexible element). For example, areas of adhesive 11 may be applied in a grid pattern or in stripes extending across the substrate layer. The areas of adhesive are deposited in a pattern which provides spaced-apart locations for affixing fibres 8 to the substrate layer.

In block 23 the substrate layer is stretched by sliding clamps 34, 35 apart by a set amount. The amount of stretch 50 applied is preferably between 5% and 25% of the length of the substrate layer. Clamps 34, 35 are locked in place when the desired degree of stretch has been achieved. A stop may be provided to stop the travel of one or both of clamps 34, 35 when a desired degree of stretch has been achieved. An actuator may be provided to move clamps 34, 35 apart by an amount sufficient to achieve a desired degree of stretch.

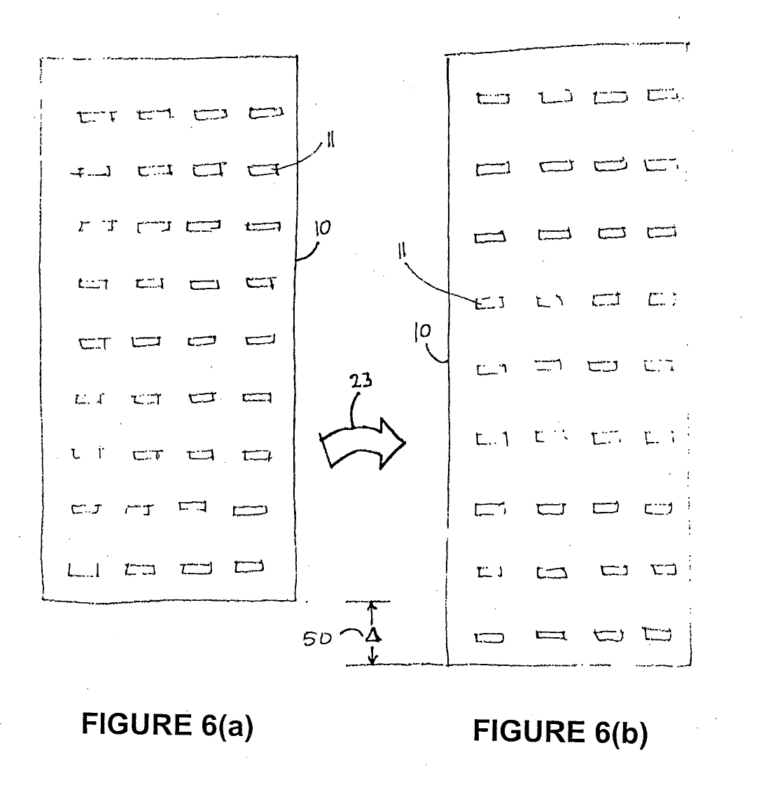

FIGS. 6A and 6B illustrate changes that occur in the substrate layer during block 23. For clarity, jig 30 is not shown. FIG. 6A illustrates the substrate layer in its relaxed state, with the areas of adhesive 11 applied to it (i.e. the condition of the assembly after block 22 is completed). After block 23 is completed, the configuration shown in FIG. 6B results. Stretching of the substrate layer causes the areas of adhesive 11 to be pulled apart from one another in a direction 37 of the stretch.

In block 24, fibres 8 of fibre pairs 14, 15 are applied (in a straight manner) to the areas of adhesive 11 on the stretched substrate layer. Each fibre pair 14, 15 may extend across several areas of adhesive 11. Each fibre 8 is caused to adhere to adhesive 11 at a number of spaced-apart locations along its length. Fibres 8 are preferably applied substantially parallel to direction 37. Fibres 8 may be applied at an angle to direction 37 if reduced sinuosity is desired.

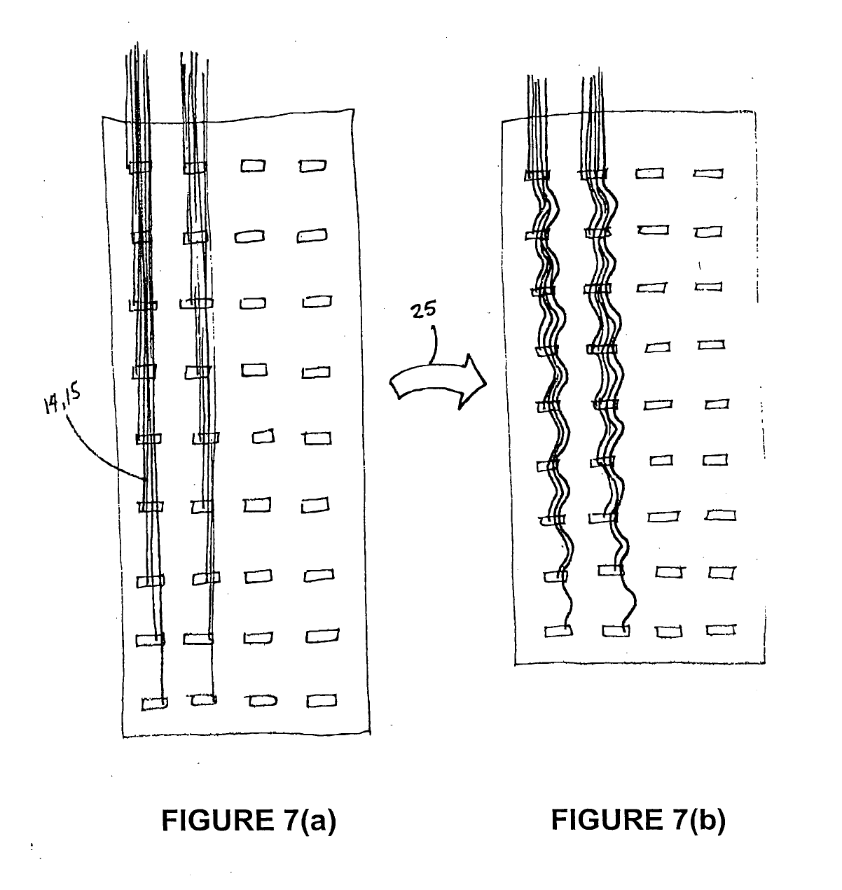

In block 25 the substrate layer is allowed to relax by sliding clamps 34, 35 back to their original positions. This is illustrated in FIGS. 7A and 7B. The condition of the assembly after block 24 is illustrated in FIG. 7A. In block 25 the tension in the substrate layer is released. This allows the substrate layer to constrict to its previous size (or near to its previous size). In so doing, the locations at which fibres 8 are attached to the elastic substrate layer move closer together and fibre pairs 14, 15 naturally assume a sinuous arrangement as shown in FIG. 7B.

Where fibres 8 are parallel to one another, when attached to the substrate layer and the locations at which fibres 8 are attached to the substrate layer are aligned with one another in stetch direction 37, it can be seen that the sinuous arrangements of fibres 8 can be made neat and complementary to one another.

In block 26 the sinuous curves of the fibre pairs are arranged as desired. The inventor has found that curves in fibres 8 may occur to either side of a line joining the points at which the fibres are attached to the substrate. If a particular arrangement is desired, the curves in fibres 8 may easily be moved left or right.

In block 27 a top layer 9 is applied to sandwich the sinuous fibres between the substrate layer 10 and top layer 9. The assembly may then be removed from jig 30 by opening jaws 32, 33 of clamps 34, 35.

The inventor has found that the operation of pressure sensors of the type described by Lokhorst et al. that are made as described herein may be improved by altering some details of the design of sensing pad 1. In particular, in some embodiments:

Bottom layer 10 (see FIG. 1) comprises an elastomer material, with sufficiently high Young's modulus (to overcome the resistance to contraction offered by fibres 8) and sufficiently high yield strength to prevent tearing during block 25 of method 20. Various materials having suitable characteristics exist. These materials include Rogers Poron™ polyurethane foam, Neoprene rubber, and the like.

Some or all of the areas of adhesive 11 may further comprise a layer of non-elastic material. The non-elastic material prevents bottom layer 10 from stretching in the immediate area of a location at which a fibre (or other elongated flexible element) is adhered to bottom layer 10. This may improve the adhesion of fibres 8 to layer 10.

Some or all areas of adhesive 11 may further comprise a layer of reflective material. A suitable such material is aluminized mylar. Providing a reflective material may improve the function of pressure sensors 5, especially in cases where bottom layer 10 is chosen for good mechanical properties even through it may have sub-optimal optical properties.

As will be apparent to those skilled in the art, in light of the foregoing disclosure there are many possible alterations and modifications in the practice of this invention without departing from the scope thereof. For example:

The invention may be applied to make sensors or products of types other than the particular sensors that are described herein as example applications of the invention.

Fibre bundles 14, 15 may each comprise a single or multiple fibres wires or other conductors.

Adhesive areas 11 may be located in any suitable pattern on the substrate layer that permits attachment of fibres or other elongated flexible elements at spaced-apart locations.

The areas of adhesive 11 may comprise adhesive strips extending in a direction substantially transverse to the direction in which the bottom layer is stretched.

The adhesive may be applied before or after arranging the elongated members on the bottom layer and before or after stretching the substrate layer.

The adhesive may be applied under the elongated elements or over top of the elongated elements.

The adhesive may comprise any suitable adhesive. Some examples of different forms that the adhesive may take are double-sided sticky tape, adhesive decals, suitable spray-on adhesive, suitable liquid adhesive; suitable hot-melt adhesive, or the like.

The elongated flexible members may be affixed to the substrate layer by means of non-adhesive fastenings such as suitable staples, clamps, barbs, or the like.

Accordingly, the scope of the invention is to be construed in accordance with the substance defined by the following claims.

What is claimed is:

1. A method for manufacturing a composite structure comprising an elastically-extendable substrate layer and one or more elongated elements, the method comprising:
in either order, applying adhesive at spaced-apart locations along the elastically-extendable layer and stretching the elastically-extendable layer;
adhering the one or more elongated elements to the stretched elastically-extendable layer and adhesive in a substantially straight manner; and,
relaxing the elastically-extendable layer to allow the spaced-apart locations to move closer to one another while allowing the elongated elements to adopt sinuous configurations.

2. A method according to claim 1 comprising arranging curves in each of the one or more elongated elements one side or the other of an axis formed by adhesion points along the elongated element.

3. A method according to claim 1 comprising applying the adhesive in spaced-apart strips extending generally perpendicular to the orientation of the one or more elongated elements.

4. A method according to claim 1 comprising applying the adhesive to the substrate layer in a grid pattern.

5. A method according to claim 1 wherein stretching the elastically-extendable layer comprises stretching the elastically-extendable substrate layer to a length that is between 5% and 25% longer than a relaxed length of the elastically-extendable layer.

6. A method according to claim 1 comprising adhering a non-elastic material to the spaced-apart locations of the elastically-extendable layer before applying the adhesive.

7. A method according to claim 1 wherein the elastically extendible substrate material has non-elastic regions.

8. A method according to claim 1 comprising adhering a reflective material to the spaced-apart locations of the elastically-extendable substrate layer before applying the adhesive.

9. A method according to claim 1 wherein the elastically extendible substrate material has reflective regions.

10. A method according to claim 1 wherein the elongated elements comprise optical fibres.

11. A method according to claim 1 wherein the elongated elements comprise wires.

12. A method for manufacturing a composite structure comprising an elastically-extendable substrate layer, and one or more elongated elements, the method comprising:
stretching the elastically-extendable layer;
laying the one or more fibre elements over the stretched elastically-extendable layer in a substantially straight manner and attaching the one or more elongated elements to the stretched elastically-extendable layer at locations spaced-apart along the elongated elements; and
relaxing the elastically-extendable layer to allow the spaced-apart locations to become closer to one another while allowing the elongated elements to adopt a sinuous configuration.

13. A method according to claim 12 comprising arranging curved portions of each of the elongated elements on one side or the other of an axis formed by attachment points along the elongated element.

14. A method according to claim 12 comprising applying an adhesive in spaced-apart strips extending generally perpendicular to the orientation of the one or more elongated elements wherein attaching the one or more elongated elements to the stretched elastically-extendable layer comprises adhering the one or more elongated elements to the adhesive.

15. A method according to claim 12 comprising applying an adhesive in a grid pattern wherein attaching the one or more elongated elements to the stretched elastically-extendable layer comprises adhering the one or more elongated elements to the adhesive.

16. A method according to claim 12 comprising stretching the elastically-extendable layer to a length that is between 5% and 25% longer than a relaxed length of the elastically-extendible layer.

17. A method according to claim 12 further comprising adhering a non-elastic material to the locations of the elastically-extendable layer before attaching the one or more elongated elements to the elastically-extendable layer.

18. A method according to claim 12 wherein the elastically-extendible layer has non-elastic regions.

19. A method according to claim 12 comprising adhering a reflective material to the locations of the elastically-extendable layer before attaching the one or more elongated elements to the elastically-extendable layer.

20. A method according to claim 12 wherein the elastically-extendible layer has reflective regions.

21. An apparatus for use in manufacturing a composite structure comprising an elastically-extendable layer and one or more elongated elements arranged in a sinuous configuration on the elastically-extendible layer, the apparatus comprising:
a support surface; and
at least one clamp adjacent to each of two sides of the support surface, and a mechanism for drawing at least one of the clamps away from another of the clamps.

22. The use of an apparatus according to claim 21 for manufacturing a composite structure comprising an elastically-extendable layer and one or more elongated elements arranged in a sinuous configuration on the elastically-extendable layer.
